(19) United States
(12) Patent Application Publication
(10) Pub. No.: US 2003/0123798 A1
(43) Pub. Date: Jul. 3, 2003

(54) Wavelength-selective optical switch with integrated Bragg gratings

(76) Inventors: Jianjun Zhang, Cupertino, CA (US); Peiching Ling, San Jose, CA (US); Jinliang Chen, Saratoga, CA (US); Ming Xu, San Jose, CA (US)

Correspondence Address: PERKINS COIE LLP, PATENT-SEA, P.O. BOX 1247, SEATTLE, WA, 98111-1247, US

(21) Appl. No.: 10/190,018

(22) Filed: Jul. 5, 2002

Related U.S. Application Data
(60) Provisional application No. 60/338,927, filed on Dec. 10, 2001.
(60) Provisional application No. 60/346,567, filed on Jan. 8, 2002.
(60) Provisional application No. 60/373,803, filed on Apr. 19, 2002.

(51) Int. Cl. G02B 6/28; G02B 6/34

(52) U.S. Cl. 385/37; 385/24

(57) ABSTRACT

The present invention discloses an optical wavelength-selective switch. The switching function is based on electrostatic bending, or moving, of a part of a waveguide with an integrated Bragg grating to control the light-signal coupling to another waveguide. The electrostatic force is introduced by voltages applied to two electrodes, one embedded in a movable waveguide and the other on another waveguide. When these two waveguides are electro-statically moved close enough, the wavelength that meets the Bragg phase-matching condition is coupled from one waveguide to the waveguide with integrated Bragg gratings. Through the coupling, the selected wavelength is then directed into a desired output waveguide.

### RELATED APPLICATIONS

Priority is hereby claimed under 35 U.S.C. §120 to U.S. Provisional Patent Application Serial No. 60/338,927 filed Oct. 22, 2001, U.S. Provisional Patent Application Serial No. 60/346,567 filed Jan. 8, 2002, U.S. Provisional Patent Application Serial No. 60/373,803 filed Apr. 19, 2002, and U.S. patent application Ser. No. 10/104,273 filed Mar. 22, 2002, each of which is incorporated by reference.

### BACKGROUND OF THE INVENTION

1. Technical Field of the Invention

This invention relates to a wavelength selective switch, and more particularly, relates to integrated Bragg grating technology as applied to optical switching applications.

2. Description of the Prior Art

Current optical switching systems usually are for optical signals covering a range of spectrum without wavelength differentiation or selection. Historically, in the wavelength division multiplex (WDM) networks of the past, adding, dropping, or cross connecting of individual wavelengths has involved conversion of the signal back to the electrical domain. More recent development of the optical switches now provide an advantage that the optical signals are switched entirely in the optical domain without converting these signals into electrical signals. However, due to the multiplexing and de-multiplexing requirements by discrete components, the cost and size of these switches is high. It is desirable to have wavelength selective switching and routing capability.

### BRIEF DESCRIPTION OF THE DRAWINGS

The nature, advantages and various additional features of the invention will appear more fully upon consideration of the illustrative embodiments now to be described in connection with the accompanying drawings, wherein:

FIG. 1 illustrates a bridge-beam type switch with integrated Bragg grating element;

FIG. 2A illustrates the cross-sectional structure of a bridge-beam type switch of FIG. 1 in the “off” position;

FIG. 2B illustrates the cross-sectional structure of a bridge-beam type switch of FIG. 1 in the “on” position;

FIG. 3 illustrates a cantilever-beam type switch with integrated Bragg grating element;

FIG. 4A illustrates the cross-sectional structure of the cantilever-bean switch of FIG. 3 in the “off” position;

FIG. 4B illustrates the cross-sectional structure of the cantilever-bean switch of FIG. 3 in the “on” position;

FIG. 5 illustrates a dual cantilever-beam type switch with integrated Bragg grating element;

FIG. 6A illustrates the cross-sectional structure of the dual cantilever-bean switch of FIG. 5 in the “off” position;

FIG. 6B illustrates the cross-sectional structure of the dual cantilever-bean switch of FIG. 5 in the “on” position;

FIG. 7 is a cross-sectional view of a switch wherein the gratings are fabricated on the substrate rather than on the movable beam;

FIG. 8 is a cross-sectional view of a switch wherein the gratings are fabricated on both the substrate and the movable beam;

FIG. 9 illustrates a switch wherein the gratings are fabricated on the side of the movable beam;

FIGS. 10A and 10B illustrate a switch wherein both waveguides are fabricated on the same level; and

FIG. 11 illustrates that the grating element is filled with solid material to protect the grating from damage.

It is to be understood that these drawings are for purposes of illustrating the concepts of the invention and are not to scale.

### DETAILED DESCRIPTION

The present invention discloses a wavelength-selective optical switch. The structure of the optical switches can be manufactured using semiconductor fabrication technology, planar-lightwave-circuit (PLC) technology, and micro-electromechanical system (MEMS) technology. The switching function is based on the moving, such as by electrostatic bending, of a part of a waveguide to control the light-signal coupled to another waveguide. One or both of the waveguides have a Bragg grating formed thereon. Electrostatic bending of a waveguide can be implemented by the application of a voltage between two electrodes located on the two waveguides.

The optical signals transmitted in the input waveguide that has a wavelength that is phase-matched with the Bragg grating is coupled into a bridge waveguide. Through a coupling to the bridge waveguide, optical signals of a selected wavelength are coupled and directed into the bridge waveguide. Furthermore, the switching function can be turned off by turning off the electrostatic voltage to decouple the bridge waveguide from the input waveguide.

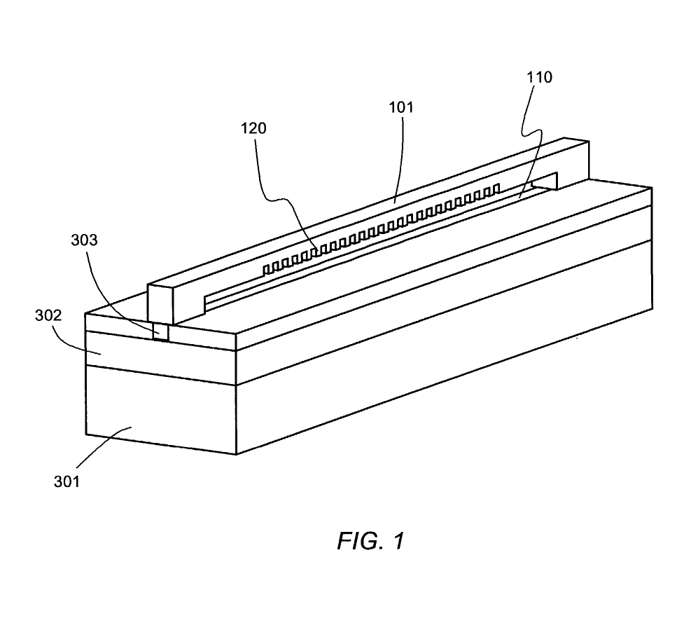

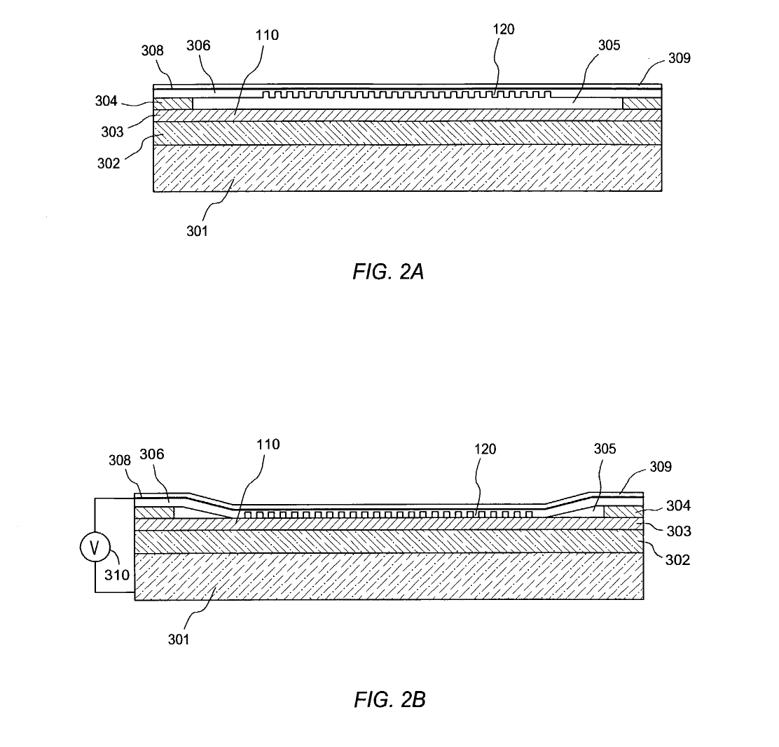

FIG. 1 depicts an illustrative embodiment of a bridge-beam type switch with integrated Bragg grating elements. The structure is fabricated using MEMS technology and semiconductor processing as described below. On the substrate 301, a cladding layer 302 is formed first. Then the core layer 303 is deposited and patterned to form waveguide core that is shown more clearly in the cross-sectional view FIG. 2A. The bridge beam 101 is a waveguide that has formed thereon a Bragg grating 120 and an embedded electrode. When this waveguide, called bridge waveguide, is electro-statically bent close enough to an input waveguide 110, the wavelength that meets the Bragg phase-matching condition is coupled into the bridge waveguide. Through the bridge waveguide, the selected wavelength can then be directed into a desired output waveguide.

FIG. 2A shows the cross-sectional view of the bridge-beam type switch. After the cladding layer 302 and core layer 303 are deposited, a sacrificial layer is deposited after another cladding layer 304 is deposited and patterned. After the sacrificial layer is patterned and the grating grooves are etched on the sacrificial layer, another cladding layer 306 is deposited. The electrode layer 308 and the insulation layer 309 are deposited subsequently. The etching process starts from layer 309 through into layer 304 after patterning. Finally the sacrificial layer is etched to form the air gap 305 between waveguide 110 and grating element 120. In an alternative way, the waveguide and the grating element can be fabricated on its own substrate first. Then they can be aligned and bonded together to make the same structure shown in FIG. 2A.

Due to the existence of air gap 305, the grating is off when no voltage is applied to the grating element. Referring to FIG. 2B, when an appropriate voltage 310 is applied between the electrode 308 and substrate 301, the grating element 120 is deflected toward input waveguide 110 by the electrostatic force. The grating is turned “on” when the grating element 120 moves sufficient close to input waveguide 110.

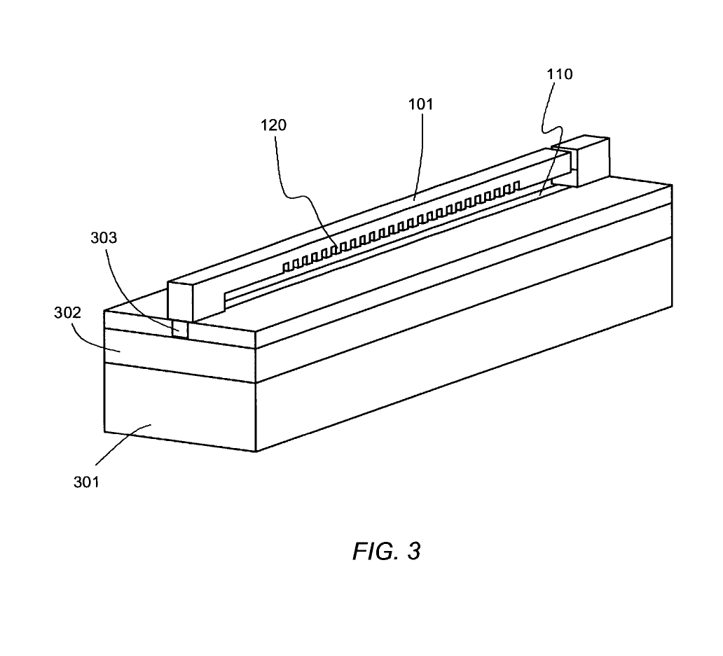

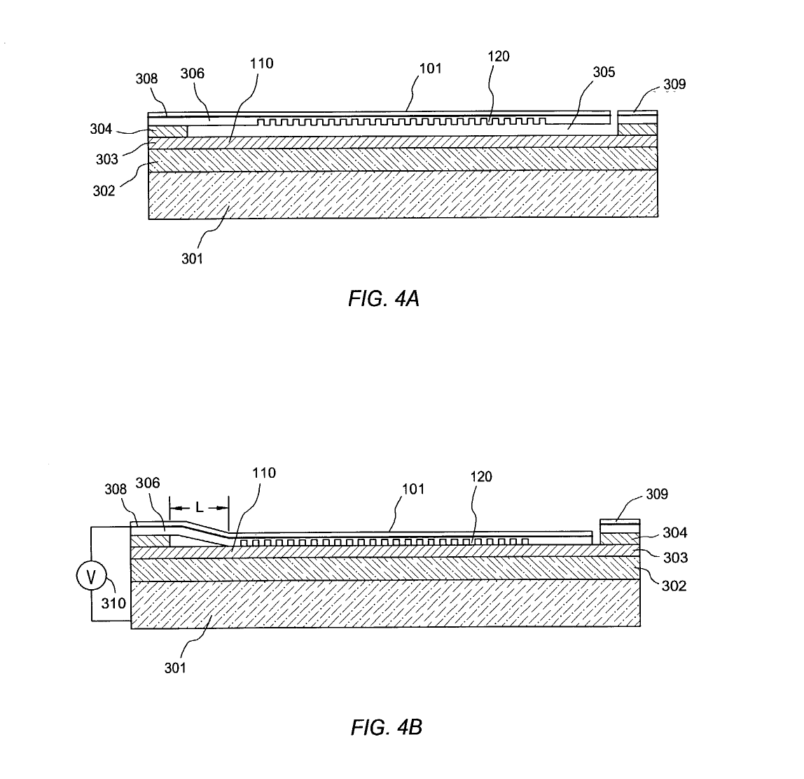

FIG. 3 depicts a cantilever-beam type switch with integrated Bragg grating elements. The structure is fabricated using similar MEMS technology and semiconductor processing described above. In this arrangement, the stress and strain in the grating segment 120 can be reduced. Therefore, the lifetime of the switch can be improved. FIG. 4A shows the cross-sectional structure of a cantilever-beam type switch. Referring to FIG. 4B, the cantilever beam 101 is deflected by an electrostatic force. The electrostatic force is controlled by applying voltage 310 between substrate 301 and electrode 308. Therefore, by controlling the applied voltage 310, the wavelength-selective optical function can be activated or deactivated.

Referring to FIG. 4B again, an adequate beam length L is required in order to deflect the beam 101 to a certain displacement within the elastic range of the material. For example, a 500 um long cantilever Si beam with a cross-section of 12 um×3 um can be easily deformed by 4 um at the tip of the beam. Another major advantage for the cantilever beam structure is that the movable beam 101 can be shorter and therefore reduce the overall size of the switch.

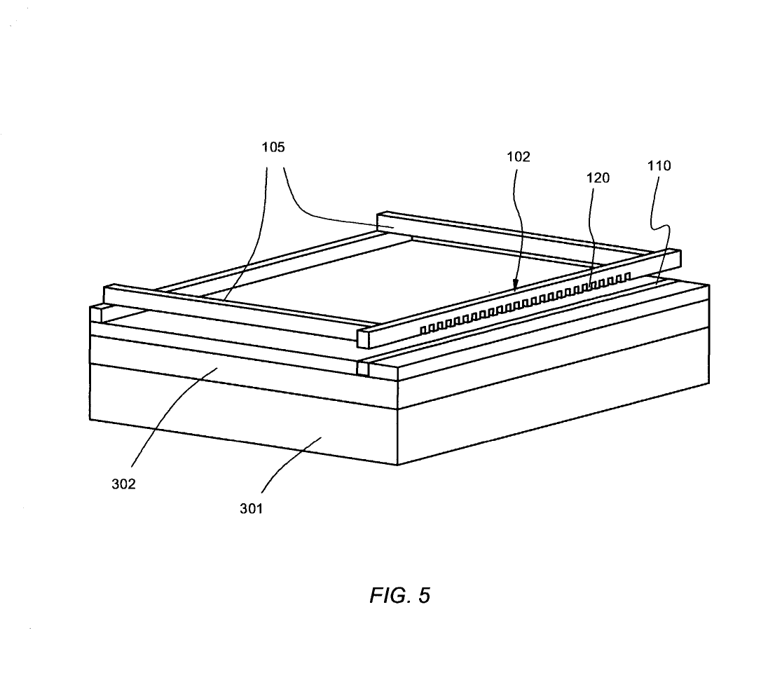

FIG. 5 illustrates another embodiment of the invention referred to as a dual cantilever-beam type switch. In this structure the grating element is fabricated on a movable beam 102, which is supported by two cantilevered beams 105. In this arrangement, the stress and strain in the grating segment can be eliminated almost completely if the electrode pattern is also located appropriately. Another advantage is that the material of the cantilever beams 105 is not necessarily the same as the material of the grating element 120. For instance, cantilever beams 105 can be made of a metal to improve the elasticity of the beams. In addition, the anchor structure can be in different forms, e.g. MEMS springs or hinges. Therefore, the large displacement and smaller size of the grating element is more achievable in this structure.

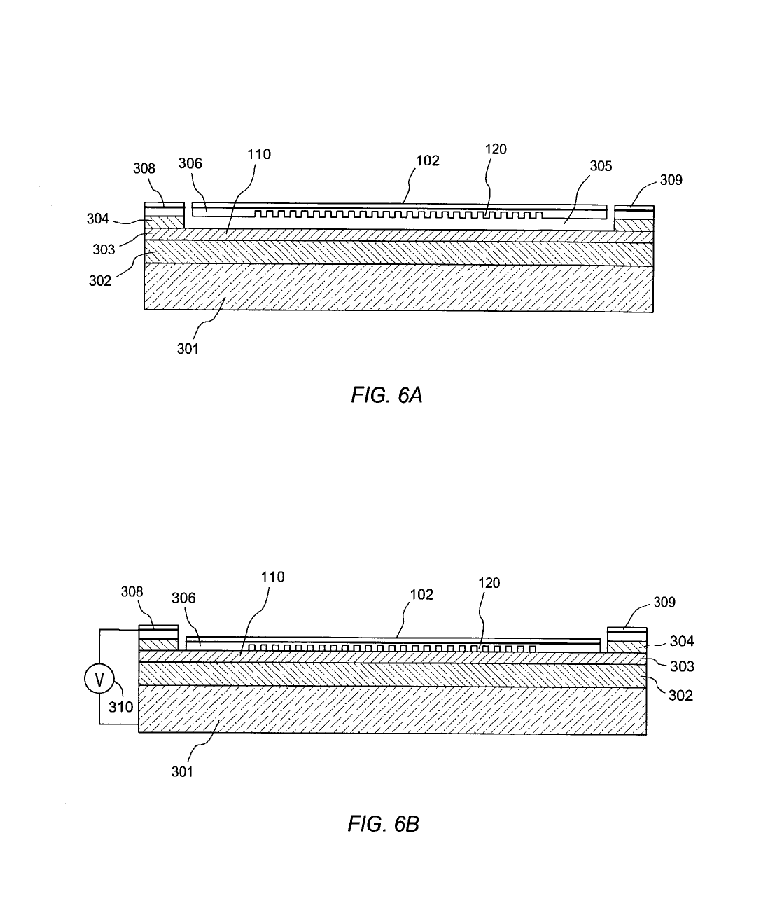

FIGS. 6A and 6B are cross-sectional views of the dual cantilever-beam type switch. Similar to the operations described above, the grating element 120 is moved towards the input waveguide 110 by applying voltages 310 to electrode 308 and substrate 301. The major difference is that the grating segment 120 is not bent during the operation.

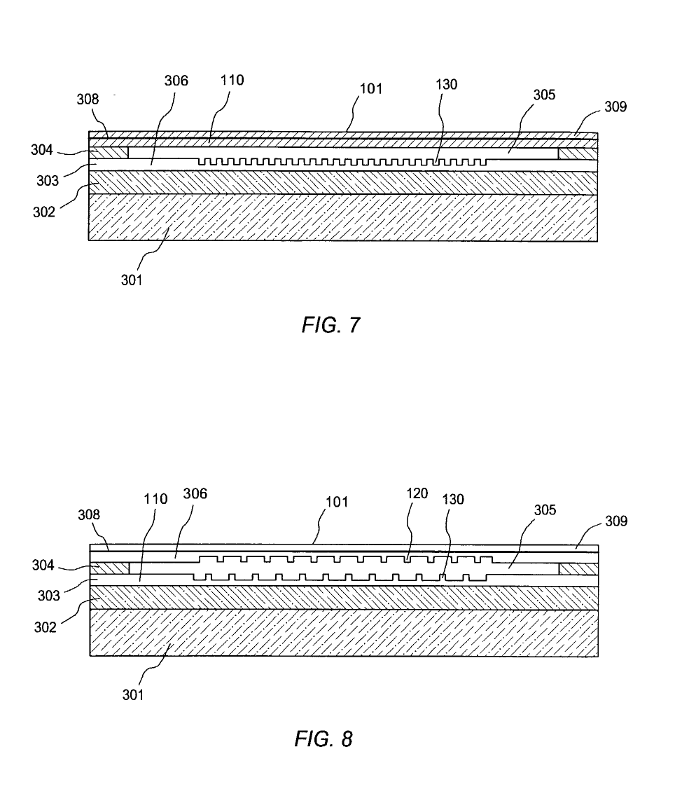

FIG. 7 shows an alternative embodiment where the grating is located on the top-surface of the substrate. The structure can be fabricated by applying semiconductor processing technology to form the Bragg gratings 130 on the core layer 303, while positioning the movable beam 101 and the Bragg gratings 130 to have a small gap 305 from the waveguide 110. Similar to the operations described above, an electric conductive layer 308 is formed on the movable beam 101 for applying the voltage to assert an electrostatic force to bend the movable beam 101. The electrostatic force thus activates the movable switch by coupling a waveguide 306 to input waveguide 110. The Bragg gratings 130 thus carry out a wavelength-selective optical switch function.

FIG. 8 is yet another alternative embodiment wherein the grating is located on both top of the core layer and the bottom of the cantilever beam. Similar semiconductor processing technology can be used to form the Bragg grating 120 on the movable beam 101 and the Bragg grating 130 on the waveguide 110. A small gap is formed between waveguides 110 and 306. An electrically conductive layer 308 is also formed on the movable beam 101 for applying the voltage to assert an electrostatic force to bend the movable beam 101. Similar to the operations described above, the electrostatic force thus activates the switch by coupling the selected wavelength from input waveguide 110 to waveguide 306.

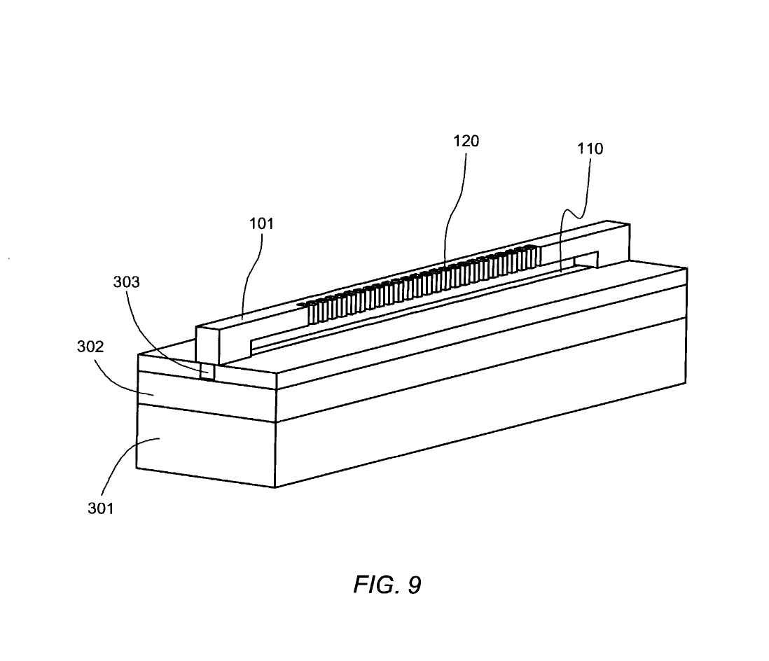

In all the structures described above, the grating element is located faced up or down to the substrate. However, the grating element can also be fabricated on the sides of the waveguide, as illustrated in FIG. 9. In this embodiment of the inventions, the gratings 120 are fabricated on the horizontal sides of the movable beam 101 and the rest of the structure are similar to those structure described above and all the wavelength-selective functions and operations are also similar to those described above. In addition, by rearranging the pattern of electrode 308, e.g. in FIG. 2A, the grating structure can also be made on the top side of the cantilever or bridge beams. Although this structure will affect the grating coupling efficiency, it provides a greater cost advantage in manufacturing.

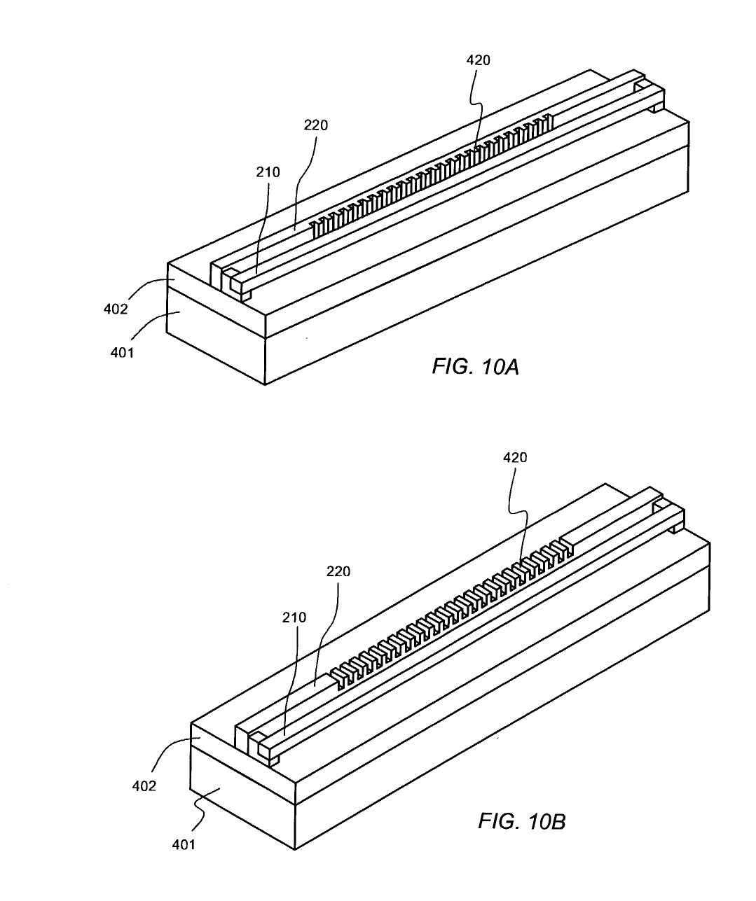

FIG. 10A shows another preferred structure of the switch. Instead of arranging the coupling waveguides as several vertical layers supported on a semiconductor substrate as shown above, the coupling waveguides 210 and 220 are formed as a planar array on a same cladding layer 402, supported on a semiconductor substrate 401. The movable waveguide 210 and coupling waveguide 220 have their own embedded electrodes, similar to those described above. Again, the Bragg gratings 420 can be formed on one or both of the waveguides 210 and 220 as described above. When electrostatic voltages are applied between these electrodes, movable waveguide 210 is moved towards waveguide 220 and thus activate the optical switch. FIG. 10B shows another structure with the gratings 420 facing upward. This structure extends the manufacturing flexibility.

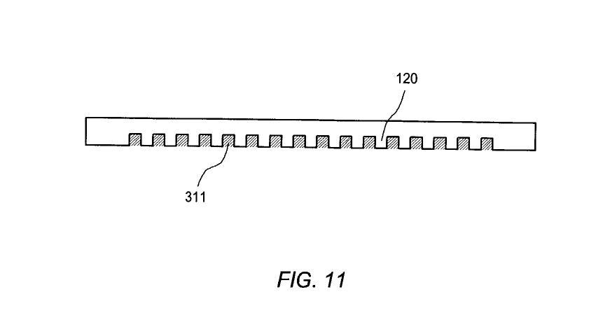

Referring to FIG. 11, a solid material 311 with low value of refractive index can be used to fill in the grating grooves to improve the reliability affected by the loading during operating. Although this structure will affect the grating coupling efficiency, it improves the lifetime of the grating element.

According to above descriptions and drawings, this invention discloses an on/off switchable wavelength-selective optical switch. The optical switch includes an input waveguide for transmitting a multiplexed optical signal therein. The optical switch further includes an on/off switchable wavelength-selective means disposed near the input waveguide, that when switched “on” will wavelength-selectively transmit a portion of the multiplexed optical signal with selected wavelengths and, that when switched “off” will continue transmitting the multiplexed optical signal. In a preferred embodiment, the on/off switchable wavelength-selective means comprises a movable coupling switch for coupling to the waveguide to wavelength-selectively transmit a portion of the multiplexed optical signal with selected wavelengths and for decoupling from the waveguide to switch off the wavelength selective switch.

In all the structures described above, the grating is in “off” state at the normal position, i.e. without applying voltages. But the structures in which the grating is normally “on” can also be easily deduced from similar fabricating process.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. An apparatus comprising:
an input waveguide for carrying a multiplexed optical signal; and
a wavelength-selective switch disposed proximate to said input waveguide, said wavelength-selective switch when in an “on” position coupling a selected wavelength from said multiplexed optical signal into an output waveguide, said wavelength-selective switch when in an “off” position allowing said multiplexed optical signal to continue propagating in said input waveguide.

2. The apparatus of claim 1 wherein said wavelength-selective switch comprises a movable coupling switching means for coupling to said input waveguide to transmit said selected wavelength of said multiplexed optical signal and for de-coupling from said input waveguide to switch off said wavelength selective switch.

3. The apparatus of claim 1 wherein said wavelength-selective switch includes a movable coupling waveguide formed with Bragg gratings for moving close and coupling to said input waveguide to wavelength selectively transmit a portion of said multiplexed optical signal with selected wavelengths phase-matched with said Bragg gratings in said coupling waveguide and for moving away and de-coupling from said input waveguide to switch off said wavelength selective switch.

4. The apparatus of claim 1 further comprising a control means for switching on and off said wavelength-selective switch.

5. The apparatus of claim 1 further comprising an electric control means for electrically switching on and off said wavelength-selective switch.

6. The apparatus of claim 1 further comprising an electrostatic control means for electrostatically switching on and off said wavelength-selective switch.

7. The apparatus of claim 3 wherein said wavelength-selective switch further includes a controllable electrode provided to selectively turn “on” said switch.

8. The apparatus of claim 3 wherein said wavelength-selective switch is formed as a movable waveguide beam disposed near said input waveguide.

9. The apparatus of claim 3 wherein said wavelength-selective switch is formed as a movable waveguide bridge having bridge supports on both ends of said movable waveguide bridge.

10. The apparatus of claim 3 wherein said wavelength-selective switch is formed as a movable waveguide having a cantilever support on one end of said movable waveguide.

11. The apparatus of claim 3 wherein said wavelength-selective switch is formed as a dual-cantilever movable waveguide having dual cantilever supports on both ends of said dual-cantilever movable waveguide.

12. An on/off controllable wavelength-selective optical switch disposed near a multiplexed optical signal transmission means comprising:
an on/off switchable wavelength-selective means when in an “on” position wavelength-selectively coupling a portion of said multiplexed optical signal and when in an “off” position allowing the continued propagation of said multiplexed optical signal.

13. The switch of claim 12 wherein wavelength-selective means has a Bragg grating formed thereon, said Bragg grating being phase-matched to said portion of said multiplexed optical signal.

14. The switch of claim 12 wherein said wavelength-selective means is a movable bridge beam.

15. The switch of claim 12 wherein said wavelength-selective means is a movable cantilever beam.

16. The switch of claim 12 wherein said wavelength-selective means is a movable dual-supported cantilever beam.

17. A wavelength-selective planar light-wave circuit comprising:
an optical switch for routing optical signals from an integrated input waveguide to an output waveguide, wherein said optical switch is a movable beam having a Bragg grating, further wherein said input waveguide and said output waveguide are proximal to each other and wherein the Bragg grating can act to wavelength-selectively alter the passage of an optical signal from input waveguide to said output waveguide.

18. The circuit of claim 17 wherein said movable beam includes an electrode.

19. The circuit of claim 18 wherein the electrode is adapted to receive a voltage in order to control the movement of said movable beam.

20. The circuit of claim 17 wherein the movable beam can be fabricated as one of a bridge, cantilever, or dual-cantilever beam structures.

21. The circuit of claim 17 wherein the Bragg grating is formed either on the top, bottom or both sides of the movable beam.

22. The circuit of claim 17 wherein the input and output waveguides can be made in either horizontal or vertical positions.

23. The circuit of claim 17 wherein said movable beam can be fabricated in the way to make said optical switch either normally on or off.

24. The circuit of claim 17 wherein said Bragg grating is filled with a material with a dissimilar refraction index.
